(19) United States
(12) Patent Application Publication
(10) Pub. No.: US 2019/0154410 A1
(43) Pub. Date: May 23, 2019

(54) DISPOSABLE SHOOTING TARGETS, TARGET SYSTEMS AND METHODS

(71) Applicant: Birchwood Casey, LLC, Eden Prairie, MN (US)

(72) Inventors: Chad Thomas Nelson, Waconia, MN (US); Raymond Floyd Tolliver, East Bethel, MN (US); Scott Benjamin Johnson, Minneapolis, MN (US)

(21) Appl. No.: 16/193,716

(22) Filed: Nov. 16, 2018

Related U.S. Application Data
(60) Provisional application No. 62/587,897, filed on Nov. 17, 2017.

(51) Int. Cl. F41J 1/00; G02C 5/00; G02C 7/10

(52) U.S. Cl. CPC F41J 1/00; G02C 7/10; G02C 5/003

(57) ABSTRACT

Embodiments include a disposable shooting target. The disposable shooting target can include a substrate, a first ink layer, a second ink layer, and a third ink layer. The first ink layer can contact the substrate. The second ink layer can be disposed over the substrate. The second ink layer can include a first color that defines a first portion of a target image. The second ink layer can also include a second color that defines a second portion of the target image. The third ink layer can be disposed over the second ink layer. The third ink layer can be partially translucent. The third ink layer can partially obscure portions of the target image. Other embodiments are also included herein.

This application claims the benefit of U.S. Provisional Application No. 62/587,897, filed Nov. 17, 2017, the content of which is herein incorporated by reference in its entirety.

### FIELD

Embodiments herein relate to shooting targets, target systems and related methods. More specifically, embodiments herein relate to a disposable shooting targets with multiple ink layers.

### BACKGROUND

Shooting targets for firearms are common. They serve as a point of aim for a shooter for both practice sessions and competitions. Traditional shooting targets commonly have various markings for a user to aim at to determine his/her accuracy when shooting the firearm. Commonly, traditional shooting target include a basic two-dimensional image, such as concentric rings, printed on a paper substrate. However, the use of traditional targets can sometimes develop or perpetuate less than ideal shooting habits, such as aiming and shooting with only one eye open.

### SUMMARY

Embodiments herein relate to shooting targets, target systems and related methods. In an embodiment, a disposable shooting target can include a substrate, a first ink layer contacting the substrate, and a second ink layer disposed over the substrate. The second ink layer can include a first color defining a first portion of a target image and a second color defining a second portion of the target image. The target can further include a third ink layer disposed over the second ink layer, wherein the third ink layer is partially translucent and wherein the third ink layer partially obscures portions of the target image.

In an embodiment, a shooting target system is included. The system can include a disposable shooting target including a substrate, a first ink layer contacting the substrate, and a second ink layer disposed over the substrate. The second ink layer can include a first color defining a first portion of a target image and a second color defining a second portion of the target image. The target can further include a third ink layer disposed over the second ink layer, wherein the third ink layer is partially translucent and wherein the third ink layer partially obscures portions of the target image. The system can also include a pair of shooting glasses, the glasses including a frame, a first lens supported by the frame, the first lens including a color corresponding to the first portion of the target image and a second lens supported by the frame, the second lens including a color corresponding to the second portion of the target image.

In an embodiment, a disposable shooting target is included. The shooting target can include a substrate and an ink layer disposed over the substrate. The ink layer can provide the appearance of a first ink layer contacting the substrate, a second ink layer disposed over the substrate, and a third ink layer disposed over the second ink layer, wherein the third ink layer is partially translucent and wherein the third ink layer partially obscures portions of the target image. The second ink layer can include a first color defining a first portion of a target image. The second ink layer can further include a second color and defining a second portion of the target image.

In an embodiment, a disposable shooting target is included having a substrate and an ink layer disposed over the substrate. The ink layer can include background segments; partially obscured background segments; first target image portion segments; partially obscured first target image portion segments; second target image portion segments; and partially obscured second target image portion segments.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following drawings, in which:

FIG. 1 is a schematic view of a shooting target, according to various embodiments.

FIG. 2 is a schematic view of a shooting target, according to various embodiments.

FIG. 3 is a schematic view of a portion of the shooting target shown in FIG. 1.

FIG. 4 is a schematic view of a portion of the shooting target shown in FIG. 1.

FIG. 5 is a schematic view of a portion of the shooting target shown in FIG. 1.

FIG. 6 is a schematic cross-sectional view of a portion of a shooting target, according to various embodiments.

FIG. 7 is a schematic cross-sectional view of a portion of a shooting target, according to various embodiments.

FIG. 8 is a schematic cross-sectional view of a portion of a shooting target, according to various embodiments.

FIG. 9 is a schematic cross-sectional view of a portion of a shooting target, according to various embodiments.

FIG. 10 is a schematic cross-sectional view of a portion of a shooting target, according to various embodiments.

FIG. 11 is a schematic cross-sectional view of a portion of a shooting target, according to various embodiments.

FIG. 12 is a schematic view of a shooting target system, according to various embodiments.

FIG. 13 is a flow chart showing a method, according to various embodiments.

FIG. 14 is a schematic cross-sectional view of a portion of a shooting target, according to various embodiments.

FIG. 15 is a schematic view of a portion of the shooting target according to various embodiments.

FIG. 16 is a schematic view of a shooting target, according to various embodiments.

While embodiments are susceptible to various modifications and alternative forms, specifics thereof have been shown by way of example and drawings, and will be described in detail. It should be understood, however, that the scope herein is not limited to the particular embodiments described. On the contrary, the intention is to cover modifications, equivalents, and alternatives falling within the spirit and scope herein.

### DETAILED DESCRIPTION

Traditional shooting targets can include a printed target image. A user can aim at the printed target image while shooting to test and improve their accuracy. Traditionally, the target image is printed on a substrate in a single color that contrasts with the substrate to help the user easily identify the target image.

Proper shooting technique generally includes the shooter keeping both of his/her eyes open while aiming at a target. However, keeping both eyes open can be difficult since many users instinctively close their opposite eye or their non-dominant eye. As used herein, the term “opposite eye” shall refer to the left eye of a shooter that is holding a firearm right-handed and the right eye of a shooter than is holding a firearm left-handed. Embodiments of targets and target systems disclosed herein can help train a user to keep both of his/her eyes open while aiming at the target and shooting a firearm.

The disposable target disclosed herein can include a target image (printed or otherwise) which the user can aim at. Various embodiments herein can provide the appearance of a three-dimensional image, such that different portions of the target image appear at different depths. The various colors can provide varying levels of contrast between the portions of the target image, such that portions of the target image with greater contrast can be more easily identified by a user than the portions of the target image with less contrast.

By way of example, different portions of the target image can be printed in different colors, such as a first color being used for a first portion of the target image, and a second color being used for a second portion of the target image. A third color can provide a background or base color for a substrate. A fourth color can be disposed on top of the first and second colors, such as to partially obscure the first and second colors. In some embodiments, the first and second colors can define substantially similar portions of the target image. The two substantially similar portions of the target image can be offset from each other.

To provide a three-dimensional effect, in some embodiments the target can be part of a system that includes a pair of shooting glasses. The shooting glasses can include two different colored lenses that correspond to the colors of the first and second colors of the offset portions in the target image, such as a left lens being the same color as a first portion of the target image and a right lens being the same color as a second portion of the target image.

In some embodiments, the system can help teach a user to keep both of his/her eyes open while aiming at the target. For example, the shooting glasses and target can be configured such that the color viewed through the user's non-dominant eye or opposite eye has more contrast than the color viewed through the user's other eye making it easier to see and distinguish from the other portions of the target. As a result, the user can have an easier time identifying the target image when the user's non-dominant eye or opposite eye is open while aiming and shooting and therefore the user is gently guided toward keeping the non-dominant eye or the opposite eye open while aiming an shooting.

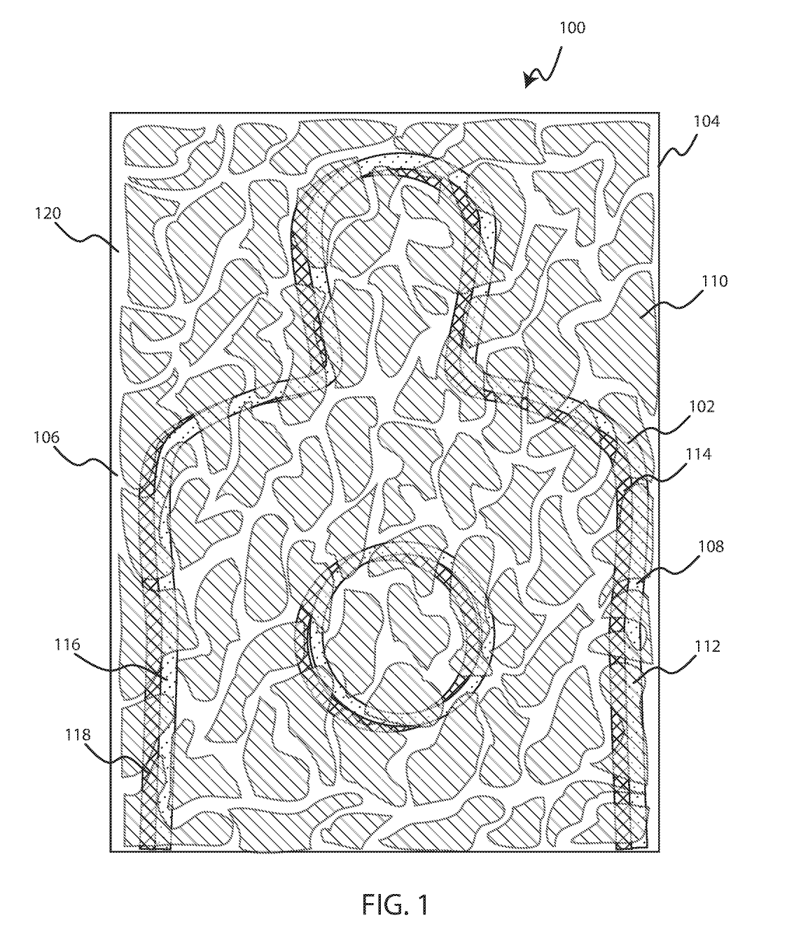

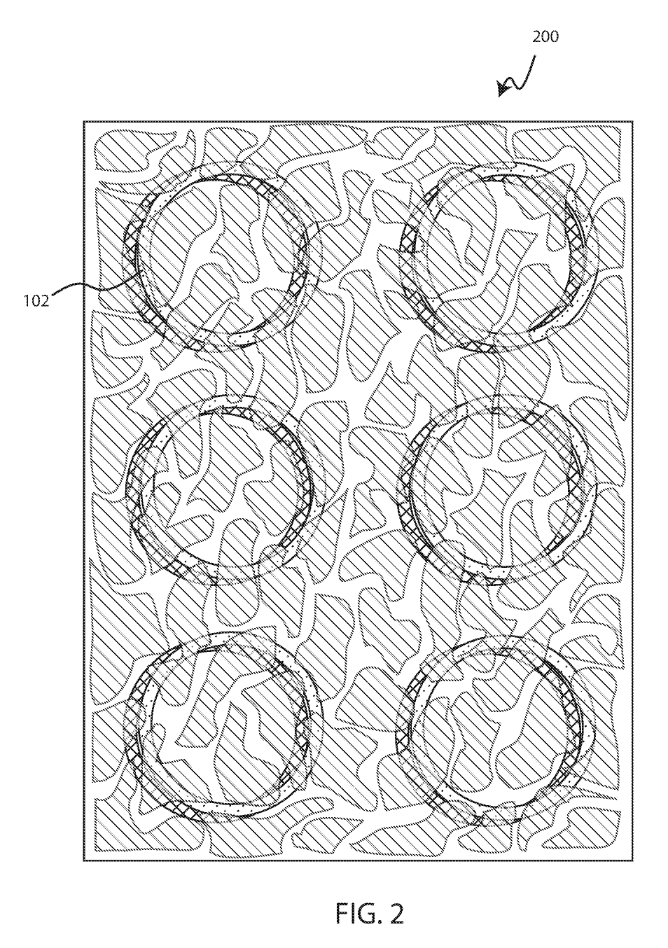

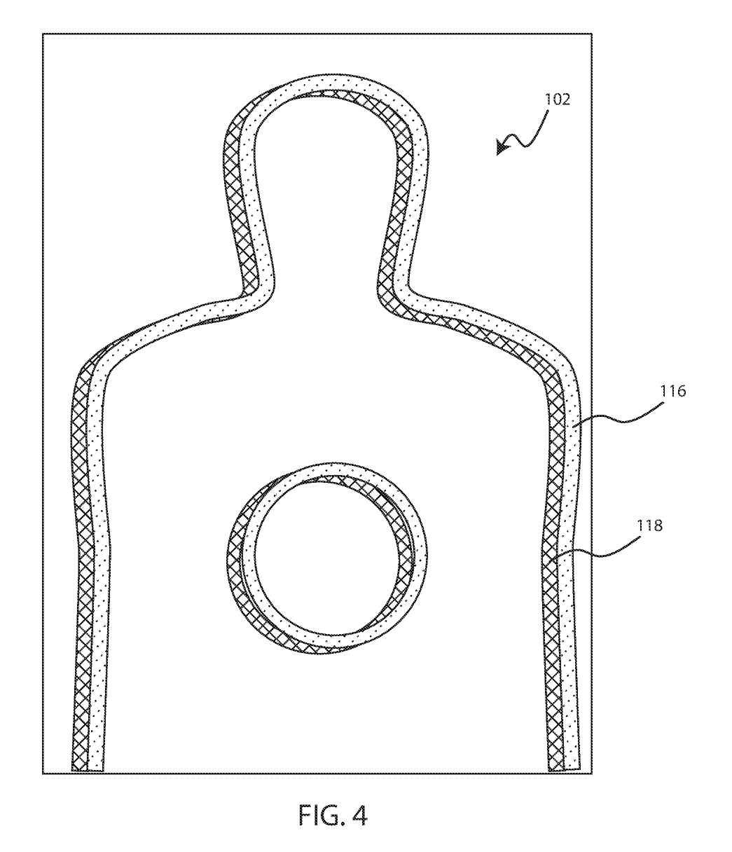

FIG. 1 shows a schematic view of a disposable shooting target 100, according to various embodiments. The shooting target 100 can include a target image or target object 102 (shown unobscured in FIG. 4), which a user can aim at or direct a projectile at. The target image 102 can be printed or otherwise applied onto a substrate 104. The target image 102 can define an image such as an animal, a silhouette (shown in FIG. 1), a person, an aiming point, or the like. Alternatively, the target image 102 can define one or more geometric shapes, such as a plurality of circles (shown in FIG. 2).

In various embodiments, the substrate 104 can include cellulosic product, such as paper or cardboard. However, in other embodiments the substrate 104 can include a printable non-cellulosic material such as a printable polymeric sheet. The target image 102 can be printed or otherwise applied onto the substrate 104. The target 100 can include a first ink layer 106, a second ink layer 108, and a third ink layer 110. The target image 102 can be defined by the second ink layer 108, which can include two or more colors of ink. The third ink layer 110 can partially obscure portions of the second ink layer 108 and thus partially obscure the target image 102.

In some embodiments, the first ink layer 106 can contact the substrate 104. In some embodiments, the first ink layer 106 can be effectively integrated into the substrate 104, such as in the case of a colored dye in the substrate that may be introduced when the substrate is first manufactured. In some embodiments, the second ink layer 108 can be disposed over the substrate 104. In some embodiments, the second ink layer 108 can be disposed over at least a portion of the substrate 104. The second ink layer 108 can include a first color 112 and a second color 114. The first color 112 can define a first portion 116 of the target image 102 and the second color 114 can define a second portion 118 of the target image 102. In many embodiments, the first portion 116 of the target image 102 and the second portion 118 of the target image 102 define the same image.

The first portion 116 can be offset from the second portion 118. In various embodiments, the offset can include a horizontal offset, a vertical offset, or both. In some embodiments, the first portion 116 of the target image 102 forms an image for a first eye of a shooter and the second portion 118 of the target image 102 forms an image for a second eye of the shooter.

The printed target 100 can further include a third ink layer 110. The third ink layer 110 can be disposed over the second ink layer 108. The third ink layer 110 can be partially translucent, such that the target image 102 can be viewed through portions of the third ink layer 110. The third ink layer 110 can partially obscure portions of the target image 102, such as the portions of the target image 102 which the third ink layer 110 is disposed over.

In various embodiments, the first ink layer 106 (which can be on or in the substrate) can include a third color 120. In some embodiments, there can be less contrast between the first color 112 and the third color 120 than there is between the second color 114 and the third color 120. The third color 120 can exhibit relatively low contrast with one of the first color 112 and the second color 114, and relatively high contrast with the other color. Less contrast between colors can make it more difficult for a user to distinguish between portions of the target image 102 and the background color formed by the first ink layer 106. Similarly, greater contrast between colors can allow the user to more easily see or distinguish portions of the target image 102 from the background color formed by the first ink layer 106.

In various embodiments, the contrast ratio between the first color (one of the at least two colors forming the target image) and the third color (background color) is less than 2.5:1. In some embodiments, the contrast ratio between the first color (one of the at least two colors forming the target image) and the third color (background color) is less than 2:1. In various embodiments, the contrast ratio between the second color (one of the at least two colors forming the target image) and the third color (background color) is greater than 2.5:1. In some embodiments, the contrast ratio between the second color (one of the at least two colors forming the target image) and the third color (background color) is greater than 3:1. In various embodiments, the contrast ratio between the first color (one of the at least two colors forming the target image) and the third color (background color) is about 1.7 and the contrast ration between the second color (one of the at least two colors forming the target image) and the third color (background color) is about 3.2:1. One technique for calculating the contrast ratios is provided in the Web Content Accessibility Guidelines (WCAG) 2.0 published on Dec. 11, 2008.

In some embodiments, the third ink layer 110 (overcoat obscuring layer) can include a fourth color 122. By way of example, the first color 112 can be blue, the second color 114 can be red, the third color 120 can be gray, and the fourth color 122 can be gray. In some embodiments, the fourth color 122 can be a lighter shade of gray than the third color 120, such as closer to white or further from black. However, it will be appreciated that the preceding specific colors are provided only by way of example and many other specific colors are contemplated herein.

The third ink layer 110 can be at least partially translucent or transparent, such as to allow underlying ink, such as the second ink layer 108, to show through the third ink layer 110. As such, the third ink layer 110 can function to obscure the target image, but not completely hide the target image. In various embodiments, the third ink layer 110 can be at least 5% translucent, such that at least 5% of light passes through. In various embodiments, the third ink layer 110 can be at least 10% translucent. In various embodiments, the third ink layer 110 can be at least 20% translucent. In various embodiments, the third ink layer 110 can be at least 30% translucent. In various embodiments, the third ink layer 110 can be at least 40% translucent. In various embodiments, the third ink layer 110 can be at least 50% translucent. In various embodiments, the third ink layer 110 can be at least 60% translucent. In various embodiments, the third ink layer 110 can be at least 70% translucent. In various embodiments, the third ink layer 110 can be at least 80% translucent. In various embodiments, the third ink layer 110 can be at least 90% translucent. In various embodiments, the third ink layer 110 can be at least 95% translucent.

FIG. 2 shows an alternative embodiment of a disposable shooting target 200. FIG. 2 is an example of a different type of target image that can be included herein. It will be appreciated that many different target images are contemplated. Some target images are relatively simple and may include only two colors. Others can be more complex and can include multiple colors including, for example, multiple shades of colors.

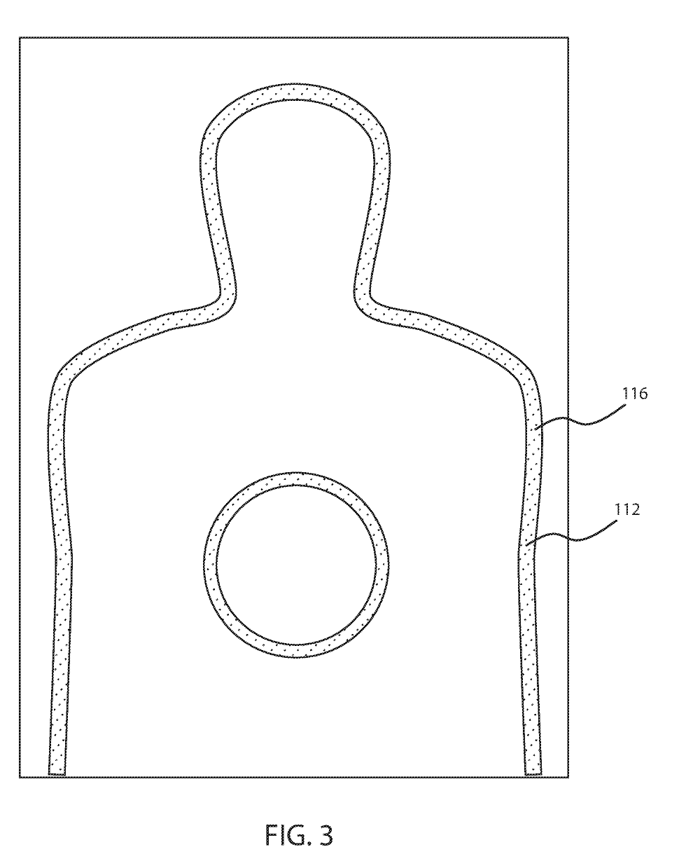

FIG. 3 shows a schematic view of a first portion 116 of the target image 102. The first portion 116 of the target image 102 can be defined by a first color 112 of the second ink layer 108. In some embodiments, the first portion 116 can include multiple discrete portions 302, 304.

FIG. 4 shows a schematic view of a target image 102. The target image 102 can include a first portion 116 defined by a first color 112 of the second ink layer 108 and a second portion 118 define by a second color 114 of the second ink layer 108. In various embodiments, the first portion 116 can be substantially similar to the second portion 118.

In various embodiments, the first portion 116 of the target image 102 and the second portion 118 of the target image 102 define the same image. In some embodiments, the first portion 116 of the target image 102 and the second portion 118 of the target image 102 can be identical in shape and size. In some embodiments, the first portion 116 of the target image 102 and the second portion 118 of the target image 102 are offset from one another. In some embodiments, the offset can include a vertical offset, a horizontal offset, or a combination of a horizontal offset and a vertical offset (as shown in FIG. 4). The offset distance can vary. In some embodiments, the offset distance can be about 1, 1.5, 2, 2.5, 3, 3.5, 4, 4.5, 5, 6, 7, 8, 9, 10, 12, 14, 16, 18, 20, 25, 30 or more millimeters. In some embodiments, the offset distance can fall within a range wherein any of the preceding distances can serve as the upper or lower bound of the range, provided that the upper bound is greater than the lower bound. In some embodiments, the offset distance can be consistent across the face of the target. In other embodiments, the offset distance can vary such that the offset near the edges of the target (for example, within 10 or 5 cm of the edge of the target) is greater than the offset near the center of the target (for example within 10 or 5 cm of the horizontal center of the target).

FIG. 5 shows a schematic view of the third ink layer 110, according to an embodiment. The third ink layer 110 can include a plurality of portions 524. In some embodiments the portions 524 can be non-connected, but in other embodiments the portion 524 can be connected. In various embodiments, the third ink layer 110 can include a random or non-repeating layout of non-connected portions 524. In some embodiments, each of the plurality of non-connected portions 524 can be a unique shape. The non-connected portions 524 can be defined by planar line segments defining shapes, non-planar line segments defining shapes, or a combination of planar line segments and non-planar line segments defining shapes.

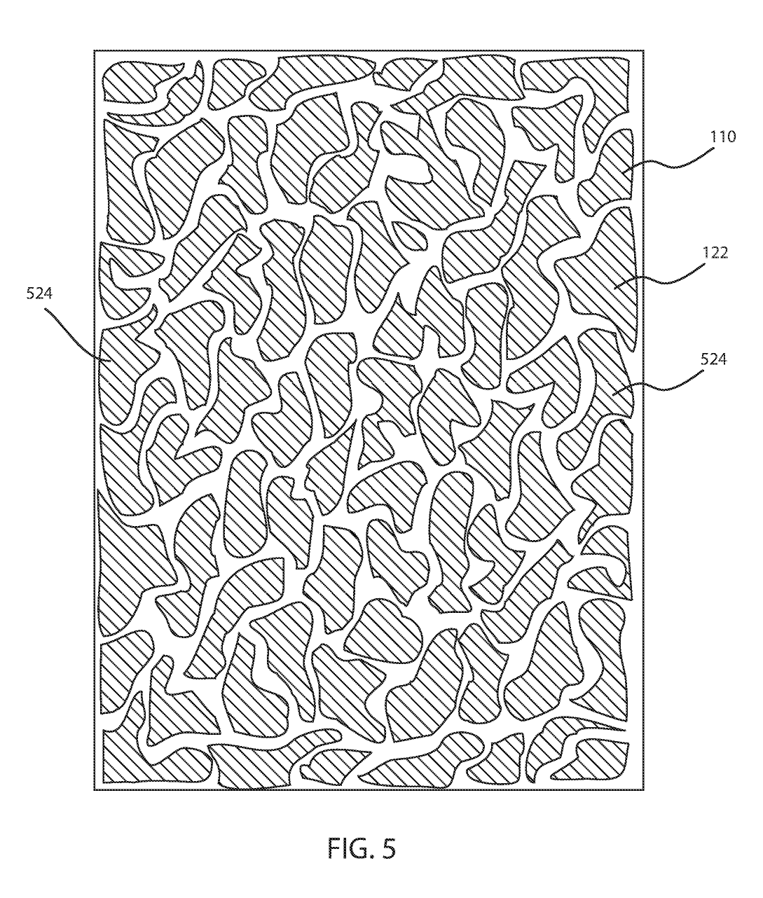

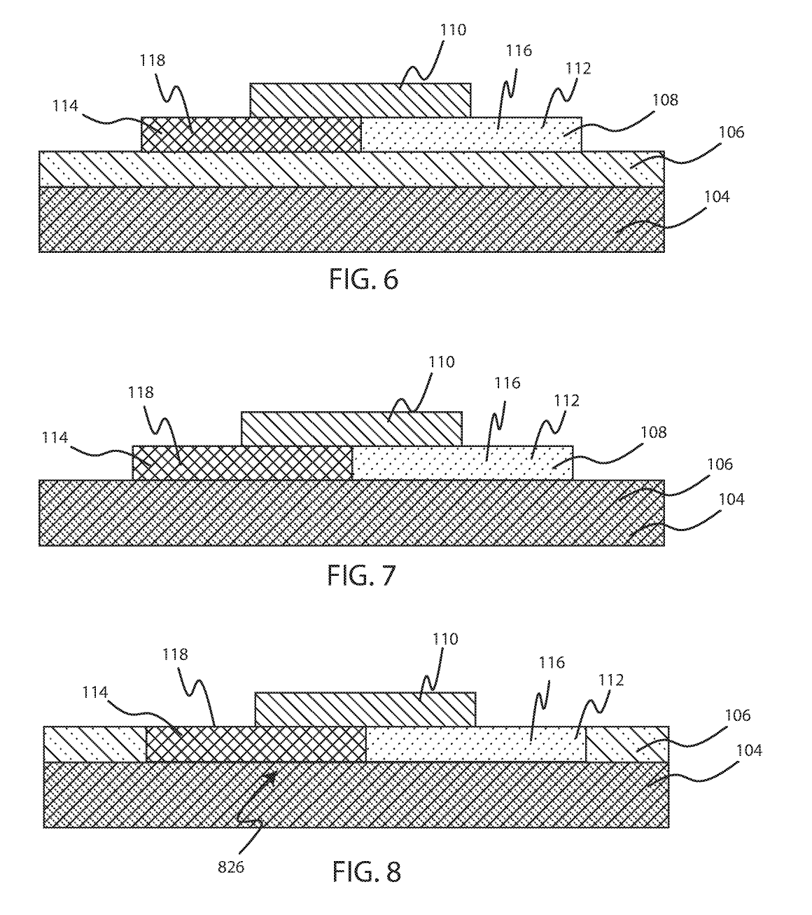

FIGS. 6-11 show schematic cross-sectional views of a portion of the target 100 according to various embodiments. As shown in FIG. 6, various embodiments of the target 100 can include the first ink layer 106 contacting the substrate 104. The first ink layer 106 can be disposed on a surface of the substrate 104, such as being disposed on a top surface of the substrate 104.

The second ink layer 108 can be disposed over the substrate 104. In various embodiments, the second ink layer 108 can be exclusively disposed on one side or surface of the substrate 104. The second ink layer 108 can be disposed on at least a portion of the first ink layer 106, such that the second ink layer 108 contacts the first ink layer 106. The second ink layer 108 can include the first color 112 and a second color 114. As discussed above, the first color 112 can define a first portion 116 of the target image 102 and the second color 114 can define a second portion 118 of the target image 102.

The third ink layer 110 can be disposed over the second ink layer 108. The third ink layer 110 can be at least partially translucent, such that the third ink layer 110 partially obscures portions of the target image 102. The obscured portions of the target image 102 can still be visible and distinguishable from adjacent portions of the target image 102, substrate 104, or first ink layer 106. The obscured portions of the target image 102 can have a different appearance than unobscured portions of the target image 102.

In some embodiments, the first ink layer 106 can permeate the substrate 104, such as shown in FIGS. 7, 9, and 10. FIG. 7 shows a schematic cross-sectional view of a portion of a shooting target according to various embodiments. The first ink layer 106 can permeate the substrate 104, such that the first ink layer 106 can be at least partially within the substrate 104 as opposed to only being located on a surface of the substrate 104. In some embodiments, the substrate 104 can be dyed with the first ink layer 106. FIG. 7 further shows the second ink layer 108 being disposed on at least a portion of the first ink layer 106.

FIG. 8 shows an additional schematic cross-sectional view of a portion of a shooting target. In various embodiments, the first ink layer 106 can be disposed on a surface of the substrate 104. In some embodiments, the first ink layer 106 defines a plurality of gaps 826, such as shown in FIG. 8. As also shown in FIG. 8, the second ink layer 108 can be disposed within the gaps 826, such that the second ink layer 108 can also be disposed on a surface of the substrate 104.

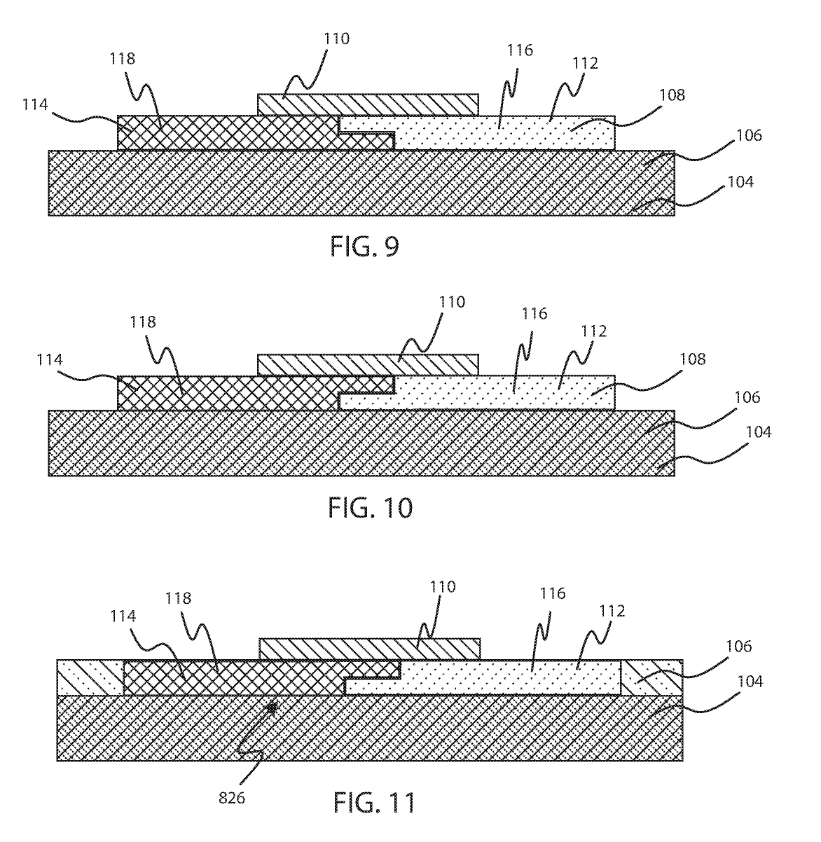

As shown in FIGS. 9-11, in various embodiments a portion of the first color 112 of the second ink layer 108 can overlap a portion of the second color 114 of the second ink layer 108, or a portion of the second color 114 of the second ink layer 108 can overlap a portion of the first color 112 of the second ink layer 108. However, in other embodiments precise registration of the inks may not result in overlaps.

By way of example, FIG. 9 shows a schematic cross-sectional view of a portion of a shooting target, according to various embodiments. As discussed above, in some embodiments, the first ink layer 106 can permeate the substrate 104. The second ink layer 108 can be disposed over the substrate 104. In some embodiments, the first color 112 of the second ink layer 108 can overlap a portion of the second color 114 of the second ink layer 108. The first color 112 can overlap the second color 114, such that a portion of the second color 114 is disposed between the first color 112 and the substrate 104.

As another example, in alternative embodiments, a portion of the second color 114 can overlap a portion of the first color 112, such as shown in FIG. 10. In such embodiments, a portion of the first color 112 is disposed between the second color 114 and the substrate 104.

As yet another example, FIG. 11 shows a schematic cross-sectional view of a portion of a shooting target, according to various embodiments. In various embodiments, the first ink layer 106 can be disposed on a surface of the substrate 104. The first ink layer 106 can define a plurality of gaps 826. The second ink layer 108 can be disposed within the plurality of gaps 826. The first color 112 of the second ink layer 108 can at least partially overlap the second color 114 within a gap 826, or the second color 114 can at least partially overlap the first color 112 within a gap 826.

It will be appreciated that in some embodiments additional materials or layers beyond those shown in the examples above can be included. For example, in some embodiments, the target can include a varnish over the top of all the other layers. In some embodiments, adhesion modifying layers can be included. Various other layers and materials are contemplated herein.

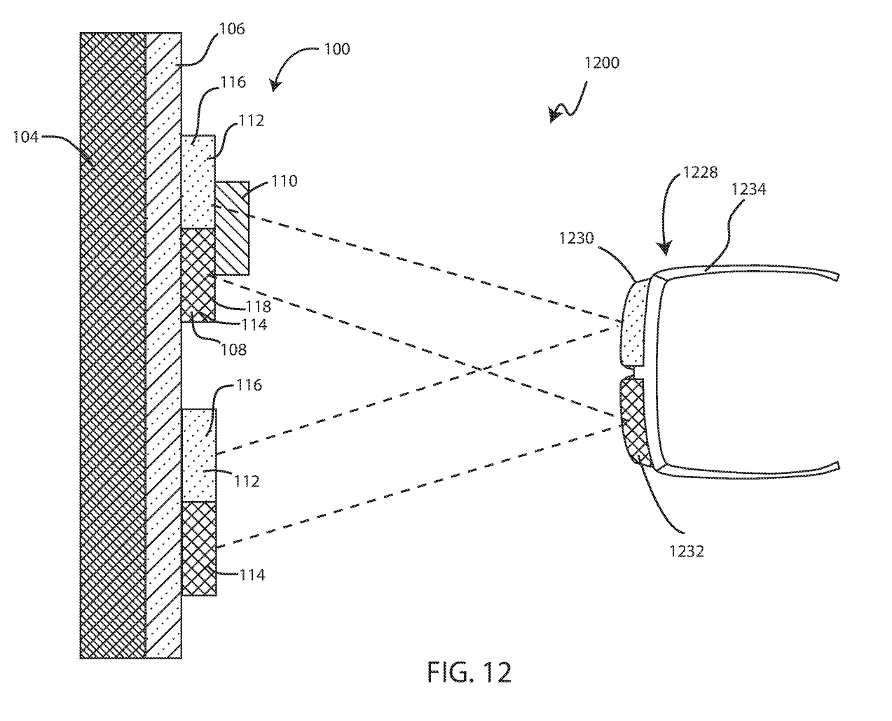

FIG. 12 shows a schematic of a shooting target system 1200, according to various embodiments. In some embodiments, the shooting target 100 as described herein can be included in a shooting target system 1200. A shooting target system 1200 can include a disposable shooting target 100 and a pair of shooting glasses 1228. The shooting glasses 1228 can include a first lens 1230, a second lens 1232, and a frame 1234 that supports the first lens 1230 and the second lens 1232.

The first lens 1230 can correspond to the first portion 116 of the target image 102. For example, the first lens 1230 can be a similar or the same color as the first color 112 defining the first portion 116 of the target image 102. Similarly, the second lens 1232 can correspond to the second color 114 defining the second portion 118 of the target image 102.

A lens 1230 or 1232 having a corresponding color to a portion of the target image 102 can make the corresponding portion of the target image 102 more visible or distinct to the user. The first portion 116 of the target image 102 can be more visible or identifiable when viewed through the first lens 1230 than when viewed through the second lens 1232. A shooting target system 1200 can be configured such that the user's non-dominant eye or opposite eye views through the lens which corresponds to the color with greater contrast. As a result, if the user closes his or her non-dominant eye or opposite eye, the user will have a more difficult time viewing the target image 102. Therefore, the user can be encouraged to maintain both eyes open with the shooting system 1200 as a result of making the target image more distinguishable to the user's non-dominant eye or opposite eye.

In some embodiments, the right lens color of the shooting glasses 1228 can correspond to the right portion color of the target image 102, and the left lens color of the shooting glasses 1228 can correspond to the left portion color of the target image 102. If a user's right eye is his/her dominant eye, the left portion of the target image 102 can be the color with the greater contrast ratio. Similarly, if the user's left eye is his/her dominant eye, the right portion of the target image 102 can be the color with the greater contrast ratio.

In some embodiments, the first lens 1230 comprises a blue color and the second lens 1232 comprises a red color, as shown in FIG. 12 for a user who shoots right-handed since red has a higher contrast ratio than blue. In some embodiments, the first lens 1230 is the right lens (used with the right eye of the user) and the second lens 1232 is the left lens (used with the left eye of the user) of the glasses 1228. In alternative embodiments, the first lens is the left lens and the second lens is the right lens. In some cases, the shooting target 100 can correspond with the shooting glasses 1228, such that a target image 102 with the right portion being the first color can include shooting glasses 1228 with the right lens corresponding to the first color. Additionally, a target image 102 with the left portion being the first color can include shooting glasses 1228 with the left lens corresponding to the first color. However, in some cases the reverse can also be true.

In various embodiments, the first lens 1230 and the second lens 1232 are integral with one another, such that the first lens 1230 and the second lens 1232 are directly connected to each other. In alternative embodiments, the first lens 1230 and the second lens 1232 are separated from one another, such as separated by the frame 1234. In some embodiments, the first lens 1230 and the second lens 1232 can be integral with the frame 1234.

Various components described herein can be combined together in order to form a kit. For example, a pair of shooting glasses can be combined with one or more targets described herein in order to form a kit. In some embodiments, a pair of shooting glasses can be combined with one or more targets described herein, along with one or more other components to form a kit. The other components can include one or more of a 3-D shooting target with offset colors that is different than the other targets described herein, a traditional paper target, a target stand, target retaining clips. In some embodiments, a photo-realistic 3-D shooting target with offset colors can be included in a kit herein.

In various embodiments, targets herein can be constructed so that shooting a bullet through them results in the formation of a contrasting halo around the bullet hole in order to increase the visibility of the bullet hole. Such targets can be referred to as “reactive targets”. For example, an adhesion modifying layer can be disposed over an underlying ink layer (which can be disposed on or integrated into the substrate). The underlying ink layer can be a bright (bright red, green, orange, purple, etc.) or otherwise high-contrast color. The other ink layers and features discussed herein can be disposed over the adhesion modifying layer. When a bullet passes through, the adhesion modifying layer causes a segment of the ink layers disposed over the adhesion modifying layer to be removed, while the underlying ink layer remains and become visible. Thus, the underlying ink layer becomes the “contrasting halo” around the bullet hole.

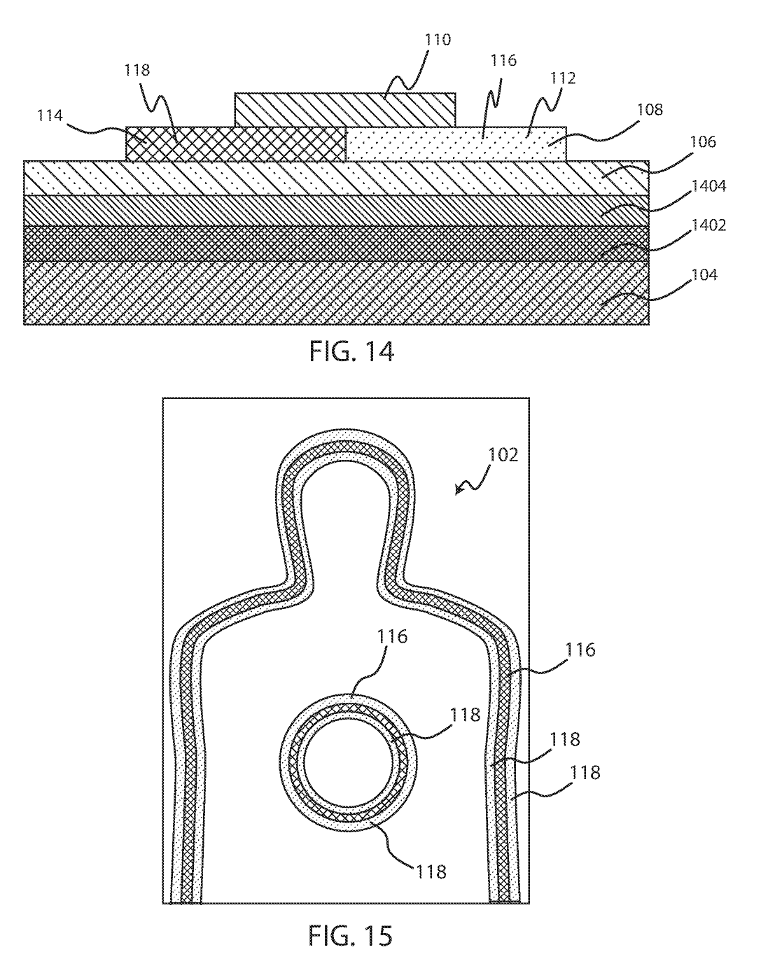

Referring now to FIG. 14, a schematic cross-sectional view of a portion of a shooting target is shown according to various embodiments. FIG. 14 generally shows the same components as shown in FIG. 6. However, the shooting target portion in FIG. 14 also includes an underlying ink layer 1402 and an adhesion modifying layer 1404.

The adhesion modifying layer 1404 can include various materials and can serve to form a reactive zone where it is present by modifying the behavior of ink that is deposited onto the adhesion modifying layer. In some embodiments, the adhesion modifying layer 1404 can include a layer of a polymeric material. By way of example, the adhesion modifying layer 1404 can include a layer of a polymer, such as polypropylene. In some embodiments, the adhesion modifying layer 1404 can include a layer of biaxially oriented polypropylene (BOPP). In some embodiments, the surface of the polymer can be treated in order to modify its surface energy. By way of example, in some embodiments, the surface of the polymer can be subjected to corona discharge treatment in order to modify the surface energy of the polymer.

In some embodiments, the adhesion modifying layer 1404 can include a layer of a release modifying agent. In some embodiments, the adhesion modifying layer 1404 can include a layer of a release varnish. The release varnish can be aqueous, solvent-based, UV-curable, electron beam curable, or the like. In some embodiments, the release varnish can include silicone compounds. In some embodiments, the release varnish can cover the entire adhesion modifying layer 1404. In other embodiments, the release varnish can cover less than the entire adhesion modifying layer 1404.

It will be appreciated that in some embodiments, the adhesion modifying layer 1404 can effectively be disposed directly on the substrate. For example, portions of the underlying ink layer 1402 can be omitted, the entire underlying ink layer 1402 can be omitted, or the underlying ink layer 1402 can be integrated into the substrate. In such embodiments, either portions of the adhesion modifying layer 1404, or the entire adhesion modifying layer 1404 can be disposed directly on the substrate.

In some embodiments, a first portion of an image and a second portion of an image are offset from one another (such as the configuration shown in FIG. 4). However, in other embodiments, the image portions may not be merely offset from one another but can have a different spatial relationship with one another such as one may surround or outline the other.

Referring now to FIG. 15, a schematic view is shown of a portion of the shooting target according to various embodiments. FIG. 15 is similar to FIG. 4, however, in FIG. 15 the image portions are not merely offset from one another. Just as with FIG. 4, this is a view of a portion of the shooting target and it will be appreciated that other layers described above can be also be present to form the shooting target. The target image 102 can include a first portion 116 defined by a first color of the second ink layer and a second portion 118 define by a second color of the second ink layer. In various embodiments, the first portion 116 can surround the second portion 118. In this configuration, only one of the first or second portions is visible if only one eye of a shooter wearing the glasses described herein is open. In many cases, this results in the target image being relatively hard to see in view of the other ink layers and color described herein. However, if both eyes of the shooter are open, then the target image becomes much easier to see. In this manner, the target system can promote the habit of the shooter keeping both eyes open.

In many embodiments, features of targets herein can be formed with different ink layers. However, in other embodiments, targets having the same or similar appearance can be formed with targets having a single ink layer and/or wherein various of the features are combined into one or more ink layers. As an example, in some embodiments, a disposable shooting target can be included that has a substrate and an ink layer disposed over the substrate. The ink layer can provide an appearance of a first ink layer contacting the substrate; a second ink layer disposed over the substrate; the second ink layer including a first color defining a first portion of a target image; the second ink layer further including a second color and defining a second portion of the target image; and a third ink layer disposed over the second ink layer, wherein the third ink layer is partially translucent and wherein the third ink layer partially obscures portions of the target image.

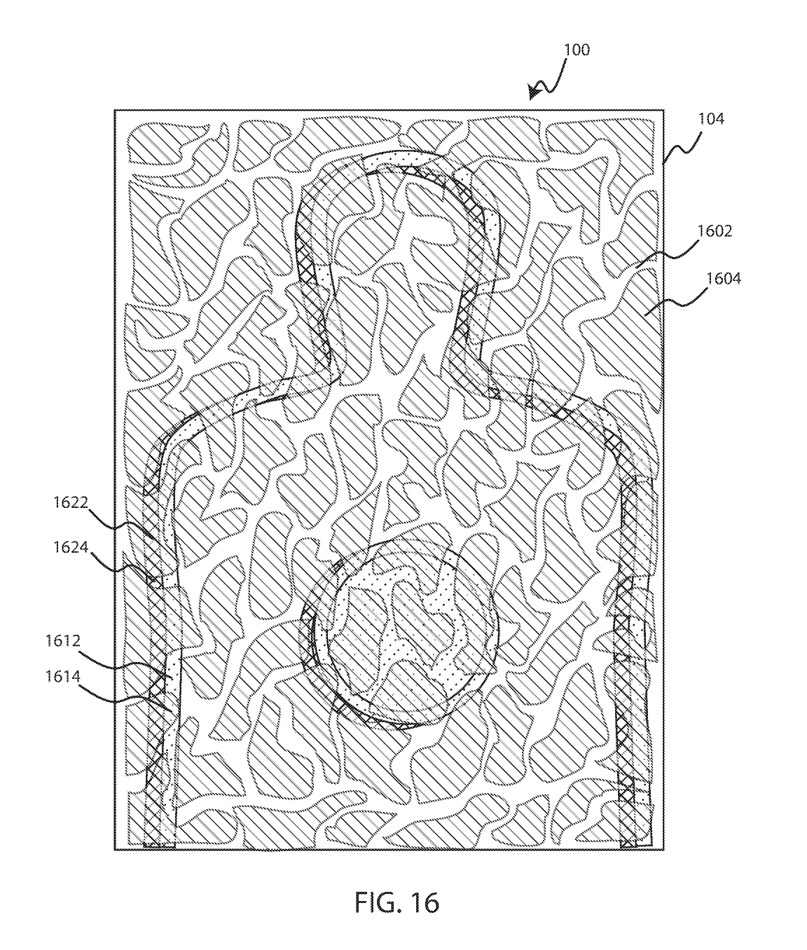

Referring now to FIG. 16, a schematic view is shown of a shooting target 100 according to various embodiments herein. The target 100 can include a substrate 104. The target 100 can further include an ink layer disposed over the substrate, the ink layer including background segments 1602, partially obscured background segments 1604, first target image portion segments 1612, partially obscured first target image portion segments 1614, second target image portion segments 1622, and partially obscured second target image portion segments 1624.

### Method

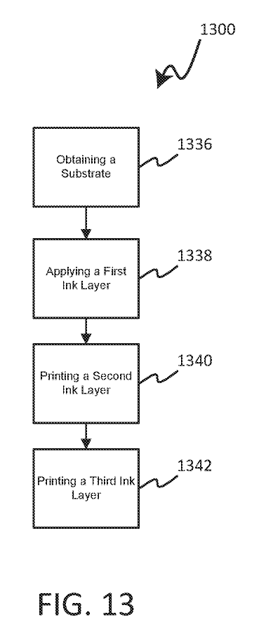

FIG. 13 is a flow chart showing a method 1300 of manufacturing a shooting target, according to various embodiments. The method 1300 can include obtaining a substrate 1336. The substrate can include a cellulosic material, such as paper. The method can include applying a first ink layer to the substrate 1338. Applying the first ink layer can include printing the first ink layer on the substrate or otherwise applying or permeating the substrate with the first ink layer.

The method 1300 can include printing a second ink layer 1340. The second ink layer can be disposed over the substrate. In some embodiments, the second ink layer can be disposed on at least a portion of the first ink layer. Printing the second ink layer can include printing a first color to define a first portion of a target image and printing a second color to define a second portion of the target image.

The method 1300 can also include printing a third ink layer 1342 disposed over the second ink layer. The third ink layer can be partially translucent, such that the third ink layer partially obscures portions of the target image. It will be appreciated, however, that in some embodiments targets can be formed by printing a single ink layer.

### Substrates

In some embodiments, the substrate can be a cellulosic material, such as a paper or cardboard in various weights. For example, in some embodiments, the substrate can be a paper having a weight of between 16 and 140 pounds basis weight. In some embodiments, the substrate can be a paper having a grammage of between 60 and 500 g/m². In some embodiments, the substrate can include non-cellulosic materials. By way of example, in some embodiments, the substrate can include polymeric materials, metal foils, laminates of different materials, and the like.

### Inks and Application

It will be appreciated that many different types of inks can be used for the ink layers herein. By way of example, inks can include water based inks, solvent based inks, flexographic inks, UV-curable inks, web offset non-heatset inks, web offset heatset inks, quickset inks, sheet-fed inks, rubber-base inks, soybean-base inks, laser inks, various types of specialty inks (including but not limited to metallic inks, luminous inks, fluorescent inks, reflective inks, glow-in-the-dark inks), and the like. In some embodiments, four-color process inks can be used. In other embodiments, spot color inks can be used. The amount of ink applied can depend on various factors including the color intensity of the ink as well as the colors of inks that may be underneath. In some embodiments, the amount of ink applied can be sufficient to create a visibly consistent color. In some embodiments, the amount of ink applied can be sufficient to create a visibly consistent color as viewed by the naked eye at a distance of greater than three feet. The amount of ink applied can be varied by a printing press operator to achieve a visibly consistent color. Application of the inks can be carried out in various ways. For example, printing techniques such as flexographic printing, offset printing, gravure printing, four-color process printing, laser printing, and the like can be used. It will be appreciated that in some embodiments the first ink layer can be at least partially within the substrate itself, such as in the case of a dye used to color a paper substrate and as such the term “disposed on” with respect to the first ink layer and the substrate shall include the circumstance wherein the first ink layer is at least partially within the substrate.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

The claims are:

1. A disposable shooting target comprising:
a substrate;
a first ink layer contacting the substrate;
a second ink layer disposed over the substrate;
the second ink layer comprising a first color defining a first portion of a target image;
the second ink layer further comprising a second color and defining a second portion of the target image; and
a third ink layer disposed over the second ink layer, wherein the third ink layer is partially translucent and wherein the third ink layer partially obscures portions of the target image.

2. The disposable shooting target of claim 1, wherein the second ink layer is disposed on at least a portion of the first ink layer.

3. The disposable shooting target of claim 1, the substrate comprising a paper.

4. The disposable shooting target of claim 3, wherein the first ink layer permeates the paper.

5. The disposable shooting target of claim 3, wherein the first ink layer is disposed on a surface of the paper.

6. The disposable shooting target of claim 1, the first ink layer comprising a third color, wherein there is less contrast between the first color and the third color than between second color and the third color.

7. The disposable shooting target of claim 1, the first ink layer comprising a third color exhibiting low contrast with one of the first color and the second color and high contrast with the other.

8. The disposable shooting target of claim 1, the first ink layer comprising a third color, wherein the contrast ratio between the first color and the third color is less than 2.5:1 and the contrast ratio between the second color and the third color is greater than 2.5:1.

9. The disposable shooting target of claim 1, the first ink layer comprising a third color, the third ink layer comprising a fourth color, wherein the first color is blue, the second color is red, the third color is gray, and the fourth color is gray.

10. The disposable shooting target of claim 9, wherein the fourth color is a lighter shade of gray than the third color.

11. The disposable shooting target of claim 1, wherein the first portion of the target image and the second portion of the target image define the same image, but are offset from one another.

12. The disposable shooting target of claim 1, wherein the first portion of the target image surrounds the second portion of the target image.

13. The disposable shooting target of claim 1, wherein the first ink layer defines a plurality of gaps and the second ink layer is disposed within the plurality of gaps of the first ink layer.

14. The disposable shooting target of claim 1, wherein the first portion of the target image forms an image for a first eye of a shooter and the second portion of the target image forms an image for a second eye of the shooter.

15. The disposable shooting target of claim 1, wherein the third ink layer is at least 10% translucent.

16. The disposable shooting target of claim 1, further comprising an adhesion modifying layer disposed over the substrate.

17. A shooting target system comprising:
a disposable shooting target comprising
a substrate;
a first ink layer contacting the substrate;
a second ink layer disposed over the substrate;
the second ink layer comprising a first color defining a first portion of a target image;
the second ink layer further comprising a second color and defining a second portion of the target image; and
a third ink layer disposed over the second ink layer, wherein the third ink layer is partially translucent and wherein the third ink layer partially obscures portions of the target image; and
a pair of shooting glasses, the glasses comprising
a frame;
a first lens supported by the frame, the first lens comprising a color corresponding to the first portion of the target image; and
a second lens supported by the frame, the second lens comprising a color corresponding to the second portion of the target image.

18. The shooting target system of claim 17, wherein the first lens comprises a blue color and the second lens comprises a red color.

19. The shooting target system of claim 17, wherein the first lens is a right lens of the glasses and the second lens is a left lens of the glasses.

20. The shooting target system of claim 17, wherein the first lens is a left lens of the glasses and the second lens is a right lens of the glasses.

21. A disposable shooting target comprising:
a substrate;
an ink layer disposed over the substrate, the ink layer providing an appearance of
a first ink layer contacting the substrate;
a second ink layer disposed over the substrate;
the second ink layer comprising a first color defining a first portion of a target image;
the second ink layer further comprising a second color and defining a second portion of the target image; and
a third ink layer disposed over the second ink layer, wherein the third ink layer is partially translucent and wherein the third ink layer partially obscures portions of the target image.

22. A disposable shooting target comprising:
a substrate;
an ink layer disposed over the substrate, the ink layer including:
background segments;
partially obscured background segments;
first target image portion segments;
partially obscured first target image portion segments;
second target image portion segments; and
partially obscured second target image portion segments.
